(19) United States
(12) Patent Application Publication
(10) Pub. No.: US 2001/0006808 A1
(43) Pub. Date: Jul. 5, 2001

(54) FERMENTATION POST-STERILE ADDITIVE DELIVERY METHOD AND APPARATUS

(76) Inventor: DREW C. COLEMAN, BOTHELL, WA (US)

Correspondence Address: LARIVIERE, GRUBMAN & PAYNE, LLP, 1 LOWER RAGSDALE, BLDG. 1, SUITE 130, P.O. BOX 3140, MONTEREY, CA, 93942, US

(21) Appl. No.: 09/354,527

(22) Filed: Jul. 15, 1999

(51) Int. Cl. C12N 1/00; C12N 1/38

(52) U.S. Cl. 435/243; 435/813; 435/244

(57) ABSTRACT

A fermentation process post-sterile additive device and method of operation is detailed. The device is used to deliver additive as a heavy-drop mist. The mist covers the entire fermenting batch head surface of the vat broth. This improves mixing and reduces the amount of additive to appropriate introduction levels throughout log phase fermentation, preventing coating of cultivating cells and interference with cell respiration. A steady state growth rate is fostered.

### TECHNICAL FIELD

The present invention relates generally to fermentation processes and apparatus and, more specifically to fermentation post-sterile additive delivery at a controlled rate through a pressurized atomizing system.

### BACKGROUND OF THE INVENTION

“Fermentation” generally is defined as simply the cultivation of micro-organisms in aerobic and anaerobic, dynamic processes. Also referred to as “zymosis,” it is the enzymatic transformation of organic substrates generally accompanied by the evolution of gas. In fermentation processes, sterilized cultivation medium components are supplied at the beginning of the fermentation. While some small scale fermentations have no additional “feeds” after inoculation of the batch, in other modes of fermentation, post-sterile additives control agents, acids, bases, fermentation inducing agents, substrate, and the like as would be known in the art—are fed into the fermentation vessel, or vat (also referred to hereinafter more simply as “the fermentor,” used synonymously for a bioreactor).

As the fermentor is generally a closed vessel, one common problem is that the evolution of gas results in the foaming of the surface of the substrates. One such post-sterile additive is an anti-foaming agent. In conventional anti-foam delivery systems, a foam detection probe senses the foam level. Upon detecting a predetermined foam level, a peristaltic pump is activated and an anti-foaming agent is pumped into the vat. Usually, the anti-foaming agent is dribbled down the interior side wall of the vat then mixed into the batch. However, at the periphery of a vat mixing is traditionally poor. Due to this sluggish method of delivery, anti-foam sits on top of the foam and swirls around the vat until it is eventually mixed and the foam level is lowered. However, by the time the foam has subsided, the pump often has delivered excess anti-foaming agent to the substrates. This excess anti-foam tends to coat the cells of the active culture, thereby interfering with cell respiration. Typically, the dissolved oxygen in the culture decreases to unacceptable levels and cell reproduction and other metabolic conditions are disturbed, even dropping to zero respiration until the cells can shed the coating. It takes a considerable amount of time for the culture to return to log-phase growth conditions.

Other known methods of dealing with surface foaming use of mechanical foam separation and removal or pneumatic foam breakers. Such systems are more expensive and generally less effective than the injection of anti-foaming agents.

Moreover, other post-sterile additives, again often introduced in the same manner as anti-foaming agents, have been found to be in need of closer controls because of their effect on the metabolic state of the batch. Ammonia is commonly used to maintain a pH of 7.0 during fermentation processes. It is common to wait until a pH of about 6.8 is monitored before adding the ammonia, mixing, and raising the pH to about 7.1. It has been found that this pH swing is also disturbing to an effective cell growth fermentation. In fact, it is desirable to keep the pH between 6.98 and 7.01 to promote a steady cell metabolism. A second additive in this category is carbon source additives, such as glucose, which are important to control to promote a steady cell growth rate.

There is a need for fermentation post-sterile additive delivery systems, controls, and processes to overcome the problems in the state of the art apparatus by creating even cell growth cycles under balanced chemical conditions.

### SUMMARY OF THE INVENTION

In its basic aspects, the present invention provides a method for maintaining a chemically balanced fermentation growth cycle by introducing post-sterile additive to a fermentation batch under controlled conditions. The method includes the steps of: starting a known manner fermentation process of the batch wherein the batch has a predetermined surface area; waiting until an end to a lag phase and start of a log phase; monitoring fermentation parameters during the log phase; periodically introducing at least one post-sterile additive as a substantially homogeneous mist such that the surface area is substantially covered with the mist and mixing of the additive with the batch is optimized, wherein the operational parameters for the step of periodically introducing is determined by fermentation condition feedback information from the monitoring such that a substantially steady state metabolic condition is maintained for the batch through the log phase.

Another basic aspect of the present invention is a fermentor system, including: a fermentation vessel, having an interior chamber for containing a fermentation batch therein and a closure superjacent a surface of the batch; a controller connected to the fermentation vessel; a feedback probe associated with the batch and connected to the controller such that predetermined fermentation process parameters are monitored in real time; an additive atomizer extending through the closure into the interior chamber superjacent the surface of the batch; a post-sterile additive container, having a supply of additive therein, fluidically coupled to the additive atomizer; wherein the controller selectively activates introduction of the additive via the atomizer superjacent the surface of the batch such that a substantially homogenous spray of the additive is directed across the surface.

In another basic aspect, the present invention provides an apparatus for introducing anti-foam into a fermentation vessel to control fermentation batch surface foam, including: a monitoring probe associated with the vessel for monitoring surface foam levels of the fermentation batch within the vessel; a controllable atomizer for selectively introducing a substantially homogeneous mist of post-sterile anti-foam additive onto the surface foam during log phase foaming; a pressurized supply of anti-foam additive for fluidically coupling atomizer; a selectable valve for intermittently fluidically coupling the supply and the atomizer such that a predetermined volume of additive is introduced as the mist onto substantially all the surface foaming; and a controller, connected to the valve and the probe, for operating the selectable valve based on real time surface foaming conditions of the batch.

Some of the advantage of the present invention are:

it provides a method and apparatus for overcoming the problems of the prior art;

it can be used to add most post-sterile additives to a fermentation substrate by an automatic, controlled, and either continuous or periodic, injection;

it improves balance in the fermentation by alleviating process delays for additives that do not readily mix with the substrate;

it provides a more controlled reaction between additives and the substrate within a fermentation vessel;

its use results in a lower total volume of additives needed for a fermentor batch; and

it produces metabolic conditions in a fermentation batch that are steady-state.

The foregoing summary and list of advantages is not intended by the inventor to be an inclusive list of all the aspects, objects, advantages and features of the present invention nor should any limitation on the scope of the invention be implied therefrom. This Summary is provided in accordance with the mandate of 37 C.F.R. 1.73 and M.P.E.P. 608.01(d) merely to apprize the public, and more especially those interested in the particular art to which the invention relates, of the nature of the invention in order to be of assistance in aiding ready understanding of the patent in future searches. Other objects, features and advantages of the present invention will become apparent upon consideration of the following explanation and the accompanying drawings, in which like reference designations represent like features throughout the drawings.

### BRIEF DESCRIPTION OF THE DRAWING

FIG. 1 is a schematic drawing of the apparatus in accordance with present invention.

FIGS. 2A through 2D are post-sterile additive atomizer designs in accordance with the present invention as shown in FIG. 1.

FIG. 3 is a flow chart for the operation of the present invention as shown in FIG. 1.

FIG. 4 (Prior Art) is a graph showing typical fermentation stages.

The drawings referred to in this specification should be understood as not being drawn to scale except if specifically annotated.

### DETAILED DESCRIPTION OF THE INVENTION

Reference is made now in detail to a specific embodiment of the present invention, which illustrates the best mode presently contemplated by the inventor for practicing the invention. Alternative embodiments are also briefly described as applicable.

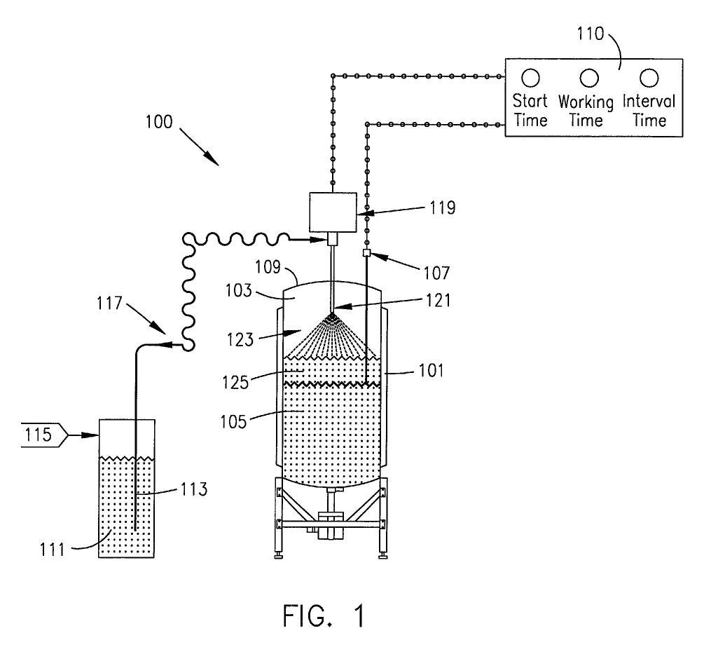

FIG. 1 is a schematic drawing of a fermentation system 100 in accordance with the present invention. A known manner fermentation vessel, or vat, 101 has an interior chamber 103 within which a batch 105 is cultivated. For the purpose of describing the details of the invention, an exemplary fermentation in which foaming is occurring and the need for an anti-foaming agent is required will be described. It will be recognized by a person skilled in the art that the following description also applies to other post-sterile additive manipulation. Therefore, no limitation on the scope of the invention is intended by the inventors in using this exemplary embodiment nor should any such limitation be implied therefrom.

Foaming is monitored by a known manner conductance probe 107 which reaches into the vat 101 through its closure, or lid, 109. The probe 107 extends to an appropriate depth proximate the surface of the batch 105 to monitor foaming conditions. The probe 107 is electrically connected to a control subsystem 110 having known manner foam condition monitoring features. The continual monitoring of conditions in the batch 105 is used as feedback as to the current conditions within the chamber 103 and is used to make real-time adjustments in controlling the additive parameters.

The post-sterile additive 111, in this exemplary embodiment, an anti-foaming agent, such as polyglycols used in the production of microbially-derived DNA products, is in a separate container 113 that is pressurized using a compressed air (or other appropriate gas) injector 115 as would be known in the art. The pressurized anti-foaming agent 111 is fed from the container 113 via an appropriate fluidic conduit 117 to a solenoid 119. The solenoid 119, which may be a commercially available, quick acting, DC-type, is electrically connected to and activated via the controller 110.

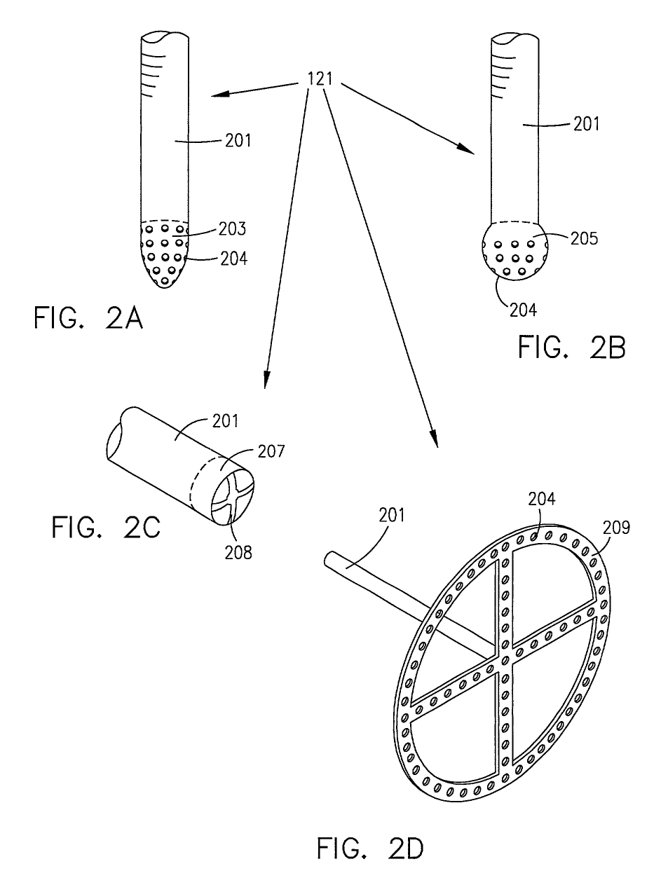

The solenoid 119 acts as a valve for introducing the anti-foaming agent 111 into the chamber 103 of the vat 101 via a hygienic atomizer 121. Turning also to FIG. 2A, a first embodiment of the atomizer 121 comprises an additive feeder tube 201 and an atomizer head, or tip, 203, having spray nozzles 204. The atomizer 121 is fabricated of a material that can be sterilized, such as 316L stainless steel. The atomizer head 203 can have a variety of implementations depending on the specific fermentation vessel 101. FIG. 2A illustrates a simple, omni-directional shower type atomizer head 203. FIG. 2B demonstrates a ball-type head 205. FIG. 2C illustrates a capillary effect type head 207, having additive distribution channels 208. FIG. 2D depicts a distribution ring head 209. As can now be recognized, a particular head can be designed to fit a particular vat 101 as needed, moving from a small tip 203, FIG. 2A, or head type 205, 207 for relatively small scale fermentors to a ring head 209, FIG. 2D, for large scale fermentors. The particular atomizer design is selected to form a substantially homogeneous mist 123 of additive 111 (FIG. 1) that will coat substantially the entire surface area of the batch with the additive. As in this exemplary embodiment, the goal is to substantially simultaneously spray a heavy drop mist of anti-foam 123 over the entire foam layer 125 which is superjacent the substrate-foam interface. It is also envisioned that the atomizer 121 may be rotated to improve the homogeneity of the mist 123.

The entire atomizer 121 should be designed such that it can be sterilized. Thus, it should be one piece. In the alternative, any joint—such as between the additive feeder tube 201 and atomizer tip 203, 205, 207, 209 (see FIGS. 2A - 2C, phantom line)—should be a weld rather than using a screw thread attachment which could harbor by contaminants, potentially destroying the desired septic environment inside the chamber 103.

Spray pressure should be controlled for most applications. For example, if the vessel chamber 103 is at 5-PSIG, the spray pressure will be up to about 10-PSIG, or approximately in the range of three to five PSIG higher than the vessel. By providing spray pressure controls in the controller 110, such as by altering the compressed air injector 115 pressure to the additive container 113, the rate of injection through the valve 119 can be automatically varied according to feedback information as to vat 101 conditions.

The operation of the post-sterile additive fermentor system 100, FIG. 101, is controlled to optimize additive introduction into the vat chamber 103 such that a chemical balance is maintained to optimize cell growth in the batch 105, where batch is defined as including the surface foam when the additive is an anti-foaming agent. In other words, the goal is to control metabolic conditions to achieve a steady state fermentation process.

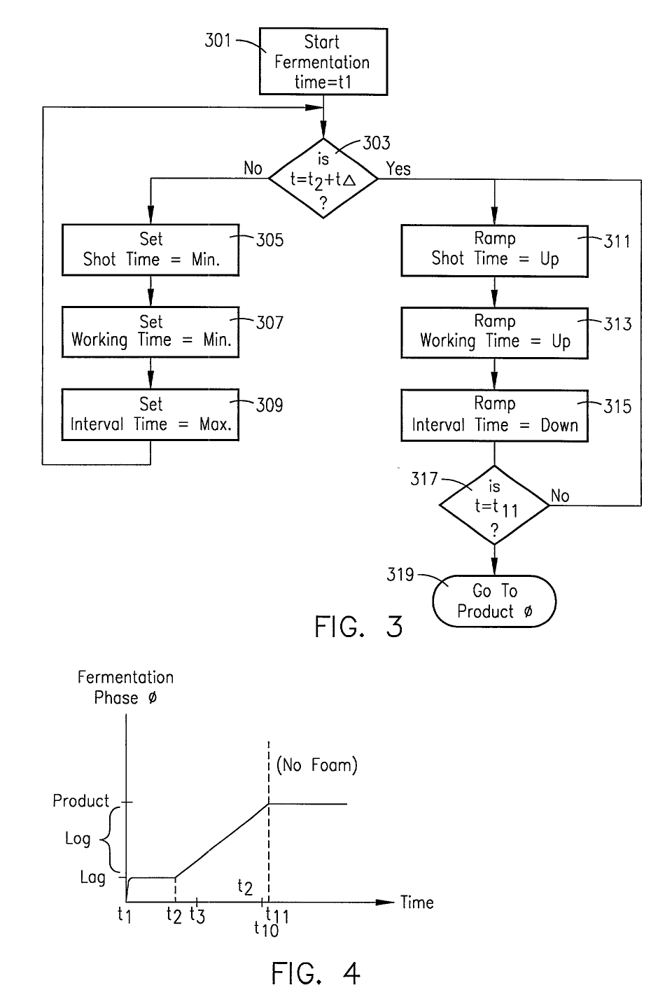

Turning to FIGS. 3 and 4, fermentation is initiated, step 301, for the particular batch 105, FIG. 1, in accordance with the known chemical, bio-chemical and chemical engineering principles appropriate to the specific process. It is known that from start of fermentation—time “t₁”—there is a fermentation “lag” phase, e.g., about four hours, before post-sterile additive introduction is initiated. Starting thereafter (at time=t₂), the “log” phase occurs during which cell cultivation is active and post-sterile additive introduction happens. After the log phase, the “product” formation phase is entered (at time=t₁₁). In the exemplary embodiment, anti-foaming agent 111 will be initiated after the start of the log phase, ending at or before the start of the product formation phase.

Providing real-time monitoring of the need for the post-sterile additive to promote a steady state log phase is provided via conductance probe 107 or other monitor associated with the batch, e.g., an optical densitometer, dissolved oxygen or glucose monitors, or a spectrophotometer. In furtherance of this goal, additive timing control, step 303, via controller 110 (FIG. 1) is provided. Note that either or both hardware and software controls can be employed in accordance with the present invention.

Three additive introduction parameters for anti-foaming agents are used:

(1) “shot” time, viz. the duration of the additive spray cycle,

(2) “working” time, viz. agitation cycle to mix the additive with the batch, and

(3) “interval” time, viz. the delay between additive introductions.

Note again however, that additive timing control 303 can either be stepped or, if appropriate to the particular fermentation process, continuously varied; that is, interval time is dropped as a factor and the additive volume is varied up and down by varying the pressure within the additive container 113 as needed or continuously in accordance with the feedback from the real-time conditions monitor.

To continue the anti-foaming additive exemplary embodiment, at the start of the log phase, t₂, there is little foaming activity at the surface of the batch 105. Shot time, determinative of additive volume, is set to an appropriate minimum, step 305; working time is set to the appropriate minimum, step 307; and the interval time is set to the appropriate maximum, step 309. If the first anti-foaming agent introduction is at time=t₅, the controller 110 is incremented, Δt=t₂+iₓ, wherein x=an integer, to thereafter appropriately ramp the additive parameters, steps 311-315, each interval until to compensate for the increase in foaming 125 at the surface of the batch 105. Thus, after the next interval time, shot time is increased, working time is increased and interval time is decreased, in accordance with the feedback information from the probe 107. This ramping of the injection parameters continues until the last mist injection of anti-foam agent 111 at t₁₀ when shot time is at a maximum value, working time is at a maximum value and the interval between t₉ and t₁₀ was a minimum value.

As can now be recognized, at each interval a substantially homogeneous mist of the additive has been spread across the entire surface of the batch. The mixing zone is thus optimized for working the agent into the batch.

Following the end of the log phase, t₁₁, step 317, and the start the product development phase, step 319, the additives are no longer introduced.

The present invention thus provides an automated, post-sterile additive system and method for fermentation processes which is chemically balanced and establishes metabolic conditions at a substantially steady state. The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ”

What is claimed is:

1. A method for maintaining a chemically balanced fermentation growth cycle by introducing post-sterile additive to a fermentation batch under controlled conditions, the method comprising the steps of:
starting a known manner fermentation process of the batch wherein the batch has a predetermined surface area;
waiting until an end to a lag phase and start of a log phase;
monitoring fermentation parameters during the log phase;
periodically introducing at least one post-sterile additive as a substantially homogeneous mist such that the surface area is substantially covered with the mist and mixing of the additive with the batch is optimized, wherein the operational parameters for the step of periodically introducing is determined by fermentation condition feedback information from the monitoring such that a substantially steady state metabolic condition is maintained for the batch through the log phase.

2. The method as set forth in claim 1, the step of periodically introducing further comprising:
varying volume of additive introduced over time in relationship to the feedback information.

3. The method as set forth in claim 2, the step of periodically introducing further comprising:
introducing the additive in discrete shots of the mist into the batch and decreasing shot total volume over time.

4. The method as set forth in claim 3, the step of further comprising:
varying time intervals between the discrete shots of mist wherein the time intervals decrease over time.

5. The method as set forth in claim 3, the step of periodically introducing further comprising:
following each step of introducing, mixing the additive into the batch for a predetermined time period wherein the mixing time period increases over time.

6. The method as set forth in claim 3, the step of periodically introducing further comprising:
spraying the additive into a chamber superjacent the batch with a unitary, sterile atomizer means for forming the homogeneous mist.

7. A fermentor system, comprising:
a fermentation vessel, having an interior chamber for containing a fermentation batch therein and a closure superjacent a surface of the batch;
a controller connected to the fermentation vessel;
a feedback probe associated with the batch and connected to the controller such that predetermined fermentation process parameters are monitored in real time;
an additive atomizer extending through the closure into the interior chamber superjacent the surface of the batch;
a post-sterile additive container, having a supply of additive therein, fluidically coupled to the additive atomizer;
wherein the controller selectively activates introduction of the additive via the atomizer superjacent the surface of the batch such that a substantially homogenous spray of the additive is directed across the surface.

8. The system as set forth in claim 7, the atomizer further comprising:
a sterilizable, fluid coupling means for selectively connecting to the supply of additive at a proximate end thereof, and
integrally mounted on a distal end of the fluid coupling within the interior chamber superjacent the surface of the batch, spray head means for forming a substantially homogeneous mist for substantially simultaneously coating substantially the entire surface area of the batch with the additive.

9. The system as set forth in claim 7, the atomizer further comprising:
the atomizer is selectively rotatable to improve the homogeneity of the mist.

10. An apparatus for introducing anti-foam into a fermentation vessel to control fermentation batch surface foam, comprising:
a monitoring probe associated with the vessel for monitoring surface foam levels of the fermentation batch within the vessel;
a controllable atomizer for selectively introducing a substantially homogeneous mist of post-sterile anti-foam additive onto the surface foam during log phase foaming;
a pressurized supply of anti-foam additive for fluidically coupling atomizer;
a selectable valve for intermittently fluidically coupling the supply and the atomizer such that a predetermined volume of additive is introduced as the mist onto substantially all the surface foaming; and
a controller, connected to the valve and the probe, for operating the selectable valve based on real time surface foaming conditions of the batch.

11. The apparatus as set forth in claim 10, the atomizer further comprising:
a sterilizable unitary construct including an integrated spray head for generating the mist such that the anti-foam additive mist is deposited substantially uniformly on the surface foam.
